(19) United States
(12) Patent Application Publication
(10) Pub. No.: US 2008/0179147 A1
(43) Pub. Date: Jul. 31, 2008

(54) DISC ROTOR WITH GRAPHICAL STRUCTURAL ELEMENTS

(75) Inventors: Nicholas C. DeBEER, Montara, CA (US); Martin S. Dieck, Campbell, CA (US)

Correspondence Address: LEVINE BAGADE HAN LLP, 2483 EAST BAYSHORE ROAD, SUITE 100, PALO ALTO, CA, 94303, US

(73) Assignee: Dirty Dog MTB., Palo Alto, CA (US)

(21) Appl. No.: 12/014,694

(22) Filed: Jan. 15, 2008

Related U.S. Application Data
(63) Continuation of application No. PCT/US2006/027804, filed on Jul. 14, 2006.
(60) Provisional application No. 60/699,565, filed on Jul. 15, 2005.

(51) Int. Cl. F16D 65/12

(52) U.S. Cl. 188/218 XL

(57) ABSTRACT

Disc brake rotors in which figural bodies are formed by struts connecting an inner hub mounting section to an outer braking surface section are described. An entertaining variety of forms may be so-portrayed. Additional graphical features may be applied or incorporated, for example, in the outer ring of the rotor.

### CROSS-REFERENCE TO RELATED APPLICATIONS

This application is a continuation of International Application No. PCT/US2006/027804 filed Jul. 14, 2006 which claims benefit of U.S. Provisional Patent Application Ser. No. 60/699,565 filed Jul. 15, 2005, entitled, “Disc Rotor with Graphical Structural Elements”, both applications of which are incorporated herein by reference in their entirety.

### FIELD OF THE INVENTION

This disclosure relates to bicycle components incorporating graphical images as structural images, particularly those that add to the aesthetics of disc brake rotors and the overall look of the bicycle.

### BACKGROUND

Currently, bicycle component manufacturers such as Avid, Shimano, Magura and Hope companies manufacture disc rotors for bicycles. These rotors are configured with simple geometric shapes to allow the rotor to flex and expand under bicycle braking. The rotors typically use straight struts or curved struts connecting the hub attachment part of the disc to the braking surface.

Rotor sizing varies. For cross-country mountain biking applications, 160 and 165 mm rotors are prevalent. Often 160 mm rotors are simply referred to as 6-inch rotors or discs. For more extreme applications such as aggressive cross-country, freeride or tandem use, larger rotor designs offering greater mechanical advantage in service of stopping power have been developed as well. For this purpose, 180 and 185 mm rotors have been developed, and are variously referred to as 7-inch rotors. No surprisingly, rotors of a nominal 8 inch diameter have also been developed for down-hill and tandem use. And similarly, the “standard” for their size varies between 203, 205, 210 and 230 mm depending on manufacture.

In addition to such variability, various approaches to securing the disc to a hub are offered. The ISO standard is a 6-bolt connection pattern. Yet, 4-bolt pattern rotors have been produced.

In addition, Shimano, Inc. offers a “Centerlock” attachment system in which a center splined member is attached to an outer disc ring. Another 2-piece rotor system is offered by Hope, Inc., but in this case the inner attachment member uses the standard 6 bolt pattern. The center piece is aluminum in order to save weight while the outer braking surface is steel.

The invention described below offers utility in connection with any of the sizings, disc attachment and rotor construction techniques described above and as otherwise known in the art. In addition, the present invention offers graphical features new to the art.

### SUMMARY OF THE INVENTION

In the present invention, similarly functional rotors as those describe above are provided. However, otherwise solid struts are interrupted by graphics. The graphical images that connect the inner portion of the rotor for attachment to the outer portion incorporating a braking surface (e.g., one circle to another) can have components that are or are not structural.

Disc rotors for a bicycle (e.g., mountain bike, beach cruiser, cyclo-cross and road bikes), scooter or motorcycle disc brake systems incorporating graphical images as structural members of the rotor are provided. The brake rotors are configured to flex slightly upon braking. The rotors are directional, with the strut bodies forward facing to allow the rotor to expand and flex under braking and heat.

Disc brake rotors typically have a minimum of three main areas. The first area is where the rotor attaches to the hub/wheel. The second area is the braking surface (i.e. where the brake pads squeeze the rotor and create friction to slow and stop the bicycle). The third area includes struts that connect the braking surface to the inner hub connection. As referenced above, some discs can be made of multiple materials fastened together.

The rotors have an exceptional look. They utilize figural bodies adapted to flex with braking. As such, “active” graphic design components are provided. Complete figural bodies or graphical images are incorporated as the rotors' struts—as opposed to simple geometric struts that are straight or are arcs, or struts with simple graphics (e.g. saw-blade) features hanging off of the strut.

The images can all be exactly the same, or have slight variations to add to the visual effects of the graphics. To complement the graphical/structural strut components, complementary graphics may be incorporated in the braking surface, especially as part of a visual theme. Graphical images may also be laser etched (or other marking techniques) into the surface of the rotors.

The figural images employed may take a wide variety of forms. Examples shown include crossbones (of a skull and crossbones), geckos and a woman's silhouette. In any case, some elemental portion of the forms must serve as members suited for use under flex and heat expansion.

Given such conditions, the following graphical combinations (in addition to those already noted and additional ones shown in the figures) are contemplated:
dogs chasing cats as the rotor struts with bones and mice in the braking surface;
dogs as struts with bones and/or pawprints in the braking surface;
wolfes as struts howling at moons in the braking surfaces;
devils with pitchforks as struts and fire in/as braking surface;
guns/pistols as struts and bullets and/or police scene silhouettes in the braking surface;
guns as struts and knives in the braking surfaces;
guns as struts and police badges in the braking surfaces Kokopelli as struts small Kokopelli in the braking surface;
bikes as struts and mountains in the braking surface;
sharks as spokes and arms and legs in the braking surface;
surfers on surfboards as struts and waves in/as the braking surface;
vampires as struts and bats in the braking surface;
flowers as struts and in the braking surface;
skiis/snowboarders as struts and mountains and/or trees in the braking surface;
cars, trucks and/or motorcycles as struts and stop signs and/or checkered flags in the braking surface;
big cats as spokes and small game (e.g., rabbit or impala) in the braking surface;
skunks as struts and gas masks in the braking surface;
golf clubs as struts and balls and/or tees in the braking surface;
fishing rods as struts and boats and/or fish in the braking surface;
firemen as struts and axes or fire in/as the braking surface;
axes as struts and fire helmets in the braking surface; and
beer mugs as struts and toilets in the braking surface.
   In addition, a number of the various elements noted are naturally presented in other logical or comical combinations. Of course, still others base graphics are possible (e.g., aliens, dragons, ray-guns, swords). The list merely provides a sampling of the attractive and entertaining possibilities in accordance with the present invention.

Yet, those intended for use in the invention have the commonality of a recognizable figure or tangible object. As such, the rotors include “figural elements.” These elements (examples of which are provided) as presented herein refer not to single features taken from a given whole animal, etc., but rather offer a complete depiction of a given object, flora, fauna. As such, the invention involves the use of connecting struts within a disc brake rotor assembly that are not only functional, but depict complete figural bodies.

In some examples, the struts are complex so that no single uninterrupted section or portion could define an otherwise ordinary strut. In other words, one could not derive the struts by simply adding or “hanging” features onto a conventional rotor's struts. Still, some such patterns fall within the broadest conception of the current invention. However, they may be less appealing from the perspective of providing a dramatic visual departure from known devices. Yet, they may be desirable for other reasons—as in the case of naked-lady silhouettes.

As for methods according to the present invention, the subject methods may include each of the mechanical activities associated with use of the devices or systems described. As such, methodology implicit to the use of the devices described forms part of the invention. Furthermore, design methodology and the product of such processes fall within the intended scope of the invention.

### BRIEF DESCRIPTION OF THE DRAWINGS

The figures illustrate exemplary aspects of the invention. Of these figures:

FIG. 1 shows a portion of a mountain bike with a rotor according to the present invention affixed thereto;

FIG. 2 shows a plan view of the rotor in FIG. 1;

FIG. 3 shows an alien rotor configuration;

FIGS. 4A-4C shows a suite of three gecko rotors;

FIGS. 5A-5D show a suite of four dragon and fire rotors;

FIGS. 6-8 show rotors of dubious taste;

FIG. 9 shows a rotor of a figural theme like that shown in FIG. 6, but implemented in a different mechanical fashion; and

FIGS. 10A-10C show views of a “spinner” type rotor system carrying forward the same figural theme.

Further variation of the invention is contemplated from the examples shown. The figures are intended to support a generic class of device designs in which figural or otherwise complete elements are arranged to bear forces as is desirable in disc rotor units. Reference is made to these examples in a non-limiting sense. They are provided to illustrate more broadly applicable aspects of the present invention.

### DETAILED DESCRIPTION OF THE INVENTION

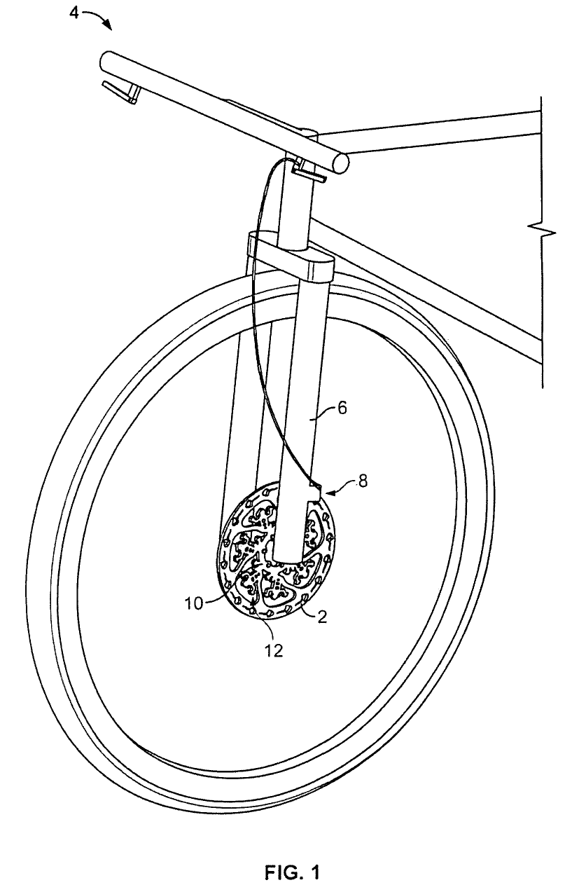

FIG. 1 shows a disc rotor 2 according to the present invention mounted to a conventional mountain bike 4. It is mounted to the bike fork 6 (rigid or suspension), which also carries disc brake calipers 8 to engage the rotor to slow and stop the bicycle.

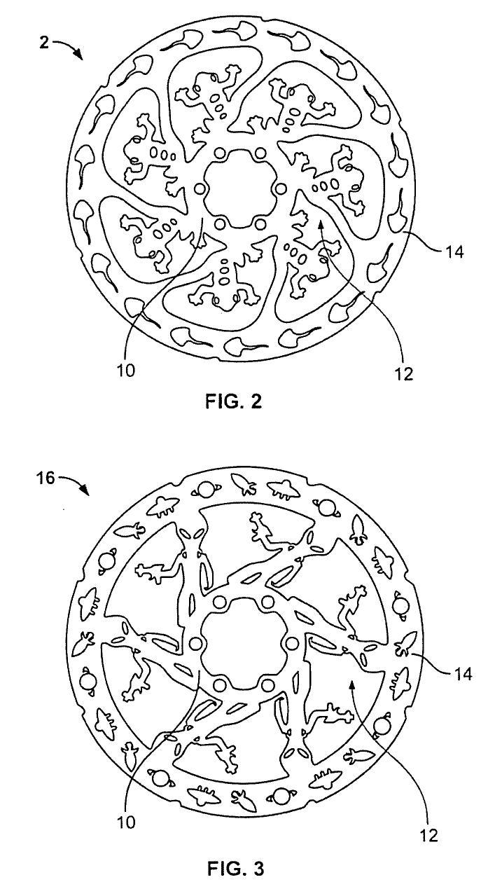

FIG. 2 provides an enlarged view of rotor 2. The rotor includes a center 6-bolt hole ring 10, struts 12, and outer ring 14 for the braking surface. Holes in the braking surface define (in their negative space) tadpole element. The struts define frogs. The hind legs provide the major structural support. Yet, they are discernable elements of the animal.

FIG. 3 shows a rotor 16 in which struts 12 are formed by extraterrestrial beings. The entire body of these aliens are incorporated as structural elements. Braking surface ring 14 includes space ships and planets. The aliens positioned about central ring 10, appear to be astride the surface of a conquered planet as they wield their ray guns. The tilt to the aliens provide not only the illusion of motion, but also the desired forward-swept strut geometry that is advantageous for proper disc function (at least when constructed of stainless steel).

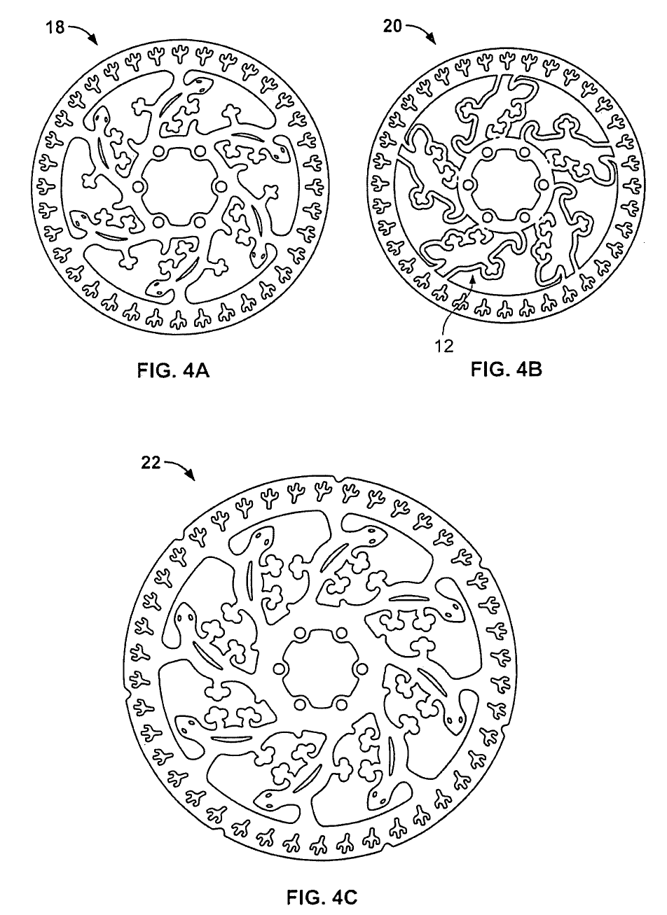

FIGS. 4A-4C shows a suite of gecko rotors. Each of the three rotors 18, 20 and 22 differ in notable ways. Rotors 18 and 20 are each 6-inch devices/components, while rotor 22 is an 8-inch piece. Of further note, struts 12 in rotor 20 define (or are defined by) the outline of the various geckos. In these, no section of the struts form a straight-line connection between the inner and outer rings of the rotor.

In view of these examples, the struts may define either positive-image or negative-image figural entities. Still further, the struts may define such recognizable shapes in a combined manner.

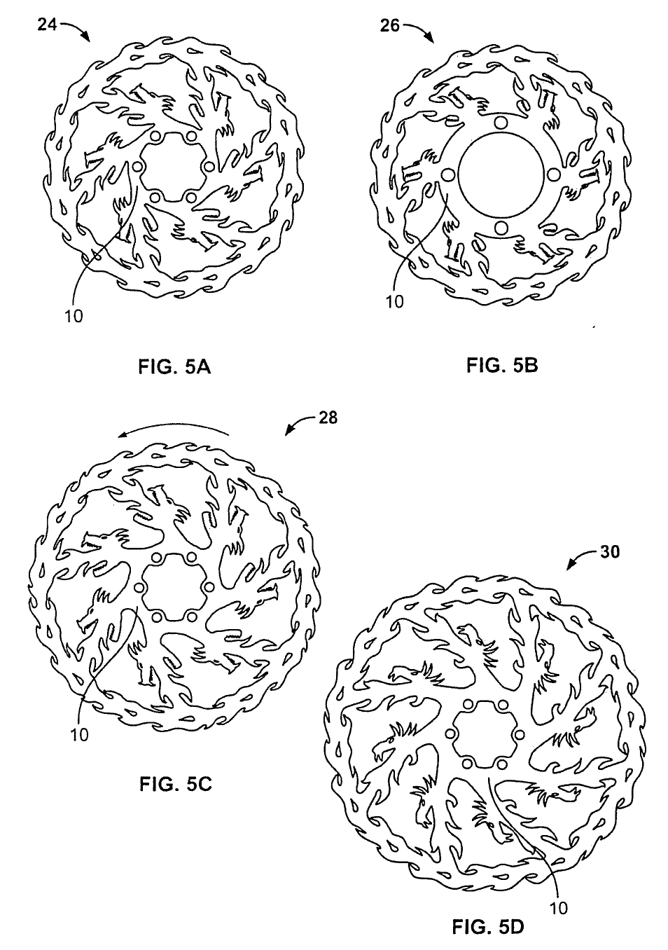

FIGS. 5A-5D illustrate a suite of dragon and fire rotors. Each of rotors 24 and 26 are 6-inch pieces. They differ primarily in their hub mounting section. Ring 10′ in rotor 26 is suited for use with a Rohloff Speedhub™, while ring 10 in rotor 24 offers a standard 6-bolt pattern as in rotors 28 and 30. Rotors 28 and 30 differ in that they are 7-inch and 8-inch pieces, respectively. And to account for the larger mechanical advantage upon the outer breaking ring, each of rotors 24/26, 28 and 30 offer progressively more strut bodies. The 6-inch rotors utilize 6, the 7-inch utilize 7, and the 8-inch utilize 8 dragon head and flame struts.

Actually, depending on the nature of the figural body depicted, more or less strut material will be available as support between the inner ring (or whatever hub mounting section provided) and the outer ring. As such, the number of struts need not follow the pattern noted above.

Another feature of interest in the FIG. 5 rotors is the manner in which braking surface ring 14 varies in its inner and outer radial extent. Stated otherwise, its inner and outer peripheries are not circular. What is more, the “flames” are directed such that the tips trail the preferred direction of disc rotation (indicated by an arrow in FIG. 5C). This orientation is desirable so that the detail and sharp points of the flames do not catch or score the brake pads of the braking system. Further, the orientation minimizes noise when braking and helps clean-out dirt, etc. from the rotors during use.

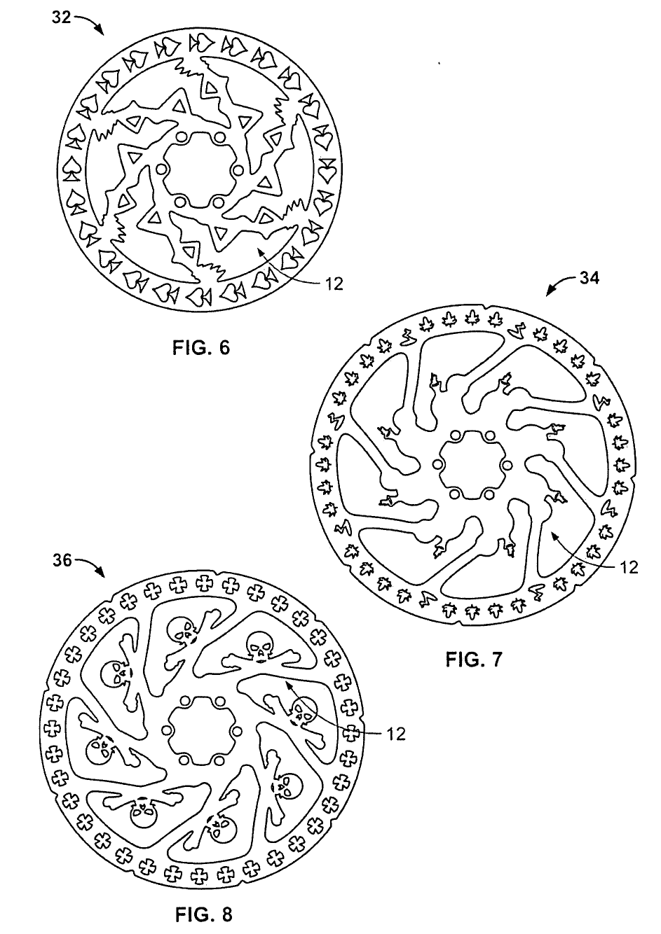

Regardless, FIGS. 6-8 illustrate other exemplary strut patterns. They also show other brake surface image pairings. Rotor 32 in FIG. 6 offers a very evocative strut 12 profile by way of risque silhouettes. The water pipes defined by struts 12 in rotor 34 of FIG. 7 speak with equal strength to freedom of expression.

While the images portrayed may not appeal to all, any number of them find a following be it in the naturalist, UFO-hunter or Rastafarian crowd. Indeed, rotor 36 displaying the skull and cross bones “Jolly Rogers” struts 12 in FIG. 8 speaks to many in the San Francisco Bay Area, given their Barbary Coast roots.

In many of the designs, as is readily observed, no section of the struts forms a straight-line or simple arcuate connection between the inner mounting section and the outer ring. In this way, the figural aspect of the elements are highlighted, while still offering adequate structure for support or force/torque transfer between the disc mounting section and its braking surface.

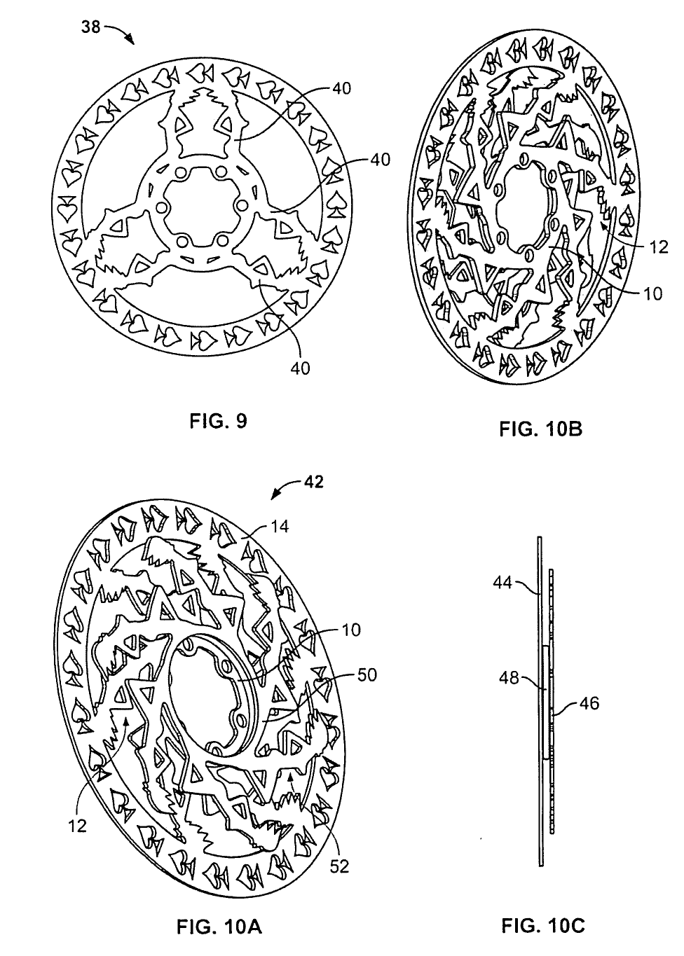

Also, it is noted that many of these devices may be run in so they rotate clockwise or counter-clockwise. In other words, the struts may be operated in tension or compression. FIG. 9 shows a rotor variation 38 in which pairs of figural-struts 40 are provided by which ones are in tension and others in compression.

FIGS. 10A-10C show a “spinner” type rotor 42 comprising a plurality of pieces. These pieces comprise the main disc 44 including hub mount ring 10, struts 12 and outer ring 14 defining the braking surface. A spinner face or cap piece 45 is rotationally mounted to main disc section 44 by a rotational bearing 48 such as a 6200 series sealed bearing as provided by Dynaroll. The attachment method at ring 50 (or otherwise) may be by snap-fit, press-fit, shrink-fit, adhesive, soldering, brazing, welding, bolting, or some other approach as known by those with skill in the art.

For weight savings the spinner piece 45 may comprise aluminum or magnesium alloy. As such, it may be anodized to add color to the system. Alternatively, is may be polished to highlight the ladies' FIG. 52. Indeed, any surface treatment or material may be employed that gives a pleasing visual effect. Still further, it is to be appreciated that this multi-piece rotor construction approach lends itself to other amusing combinations of figural elements. For instance, either one of the spinner FIG. 52 or struts 12 could be male and the other female. This way, men and women chase each other around while bicycling. In still other variations, cats chase mice or mice chase cheese, etc.

### Manufacture

The disc rotors described typically comprise stainless steel (e.g., 400-series alloy), but other materials can be used. Any suitable material or construction approach (e.g., 2-piece, etc. as noted above) may be employed for the rotors of the invention. One such other material of interest is Titanium alloy; others include carbon fiber, and ceramic material. Laminates of different material may also be employed.

The rotors shown are made by laser cutting individual pieces from large sheet stock. Once cut-out, the pieces are ground-down to a proper finish of about 63RMS. Subsequent laser-engraving may be employed to etch ornamental patterns or graphic into the non-brake surface portions of a given rotor. Etching may be employed to increase surface area for cooling. Patterns may be etched for graphic appeal and/or serve as cooling fins. Otherwise, cooling fins could be bolted, welded or otherwise affixed to the rotors. Even so, it is noted that the high surface area resulting from figural body use according to the present invention does help dissipate heat in the native design without further augmentation.

Fins could also be configured to produce sound tow warn other cyclists or animals of approach. Other details or options regarding manufacture may be appreciated in connection with the above-referenced examples as well as generally know or appreciated by those with skill in the art.

### Kits

Often, a pair of disc rotors are provided in packaged combination for sale. The rotors may be the same, or offer a complimentary set of graphics. Naturally, the discs could be provided together with brake calipers and levers as well. Such a packaged combination of products falls within the scope of the present invention. So-too do wheels and entire bicycles (typically mountain bikes) equipped with the subject disc brake rotors.

### Variations

As for other details of the present invention, materials and alternate related configurations may be employed as within the level of those with skill in the relevant art. The same may hold true with respect to method-based aspects of the invention in terms of additional acts as commonly or logically employed. In addition, though the invention has been described in reference to several examples, optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. Any number of the individual parts or subassemblies shown may be integrated in their design. Such changes or others may be undertaken or guided by the principles of design for assembly.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in the appended claims, the singular forms “a,” “an,” “said,” and “the” include plural referents unless the specifically stated otherwise. In other words, use of the articles allow for “at least one” of the subject item in the description above as well as the claims below. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Without the use of such exclusive terminology, the term “comprising” in the claims shall allow for the inclusion of any additional element—irrespective of whether a given number of elements are enumerated in the claim, or the addition of a feature could be regarded as transforming the nature of an element set forth n the claims. Stated otherwise, unless specifically defined herein, all technical and scientific terms used herein are to be given as broad a commonly understood meaning as possible while maintaining claim validity.

The breadth of the present invention is not to be limited by the examples provided.

That being said, I claim:

1. A disc brake rotor comprising:
an inner-hub mounting section,
an outer ring comprising a braking surface, and
a plurality of struts connecting the inner section and outer ring at opposite ends that are angularly offset from one another, the struts defining figural elements.

2. The rotor of claim 1, wherein the ring has a varying outer extent.

3. The rotor of claim 1, wherein the ring has a varying inner extent.

4. The rotor of claim 1, wherein the ring is imperforate.

5. The rotor of claim 1, wherein the ring includes a plurality of holes.

6. The rotor of claim 1, wherein the holes are figural.

7. The rotor of claim 5, wherein a plurality of the holes define a figural pattern together.

8. The rotor of claim 1, wherein the ring is circular.

9. The rotor of claim 1, wherein the figural elements are selected from skull and crossbones, smoking pipes, human silhouettes, flora and fauna.

10. The rotor of claim 1, comprising a metal.

11. The rotor of claim 10, comprising stainless steel.

12. The rotor of claim 11, consisting essentially of stainless steel

13. The rotor of claim 1, wherein no section of the struts form a straight-line connection between the inner mounting section and the outer ring.

14. The rotor of claim 11, wherein no section of the struts form an arcuate connection between the inner mounting section and the outer ring.

15. The rotor of claim 1, wherein the inner mounting section includes a plurality of bolt-in locations.

16. The rotor of claim 1, wherein the struts are swept forward relative to a direction of rotation when mounted.

17. The rotor of claim 1, adapted for use on a mountain bike.

18. The rotor of claim 1, comprising a plurality of pieces.

19. The rotor of claim 18, wherein one of the pieces is rotably mounted to spin relative to the braking surface.

20. A disc brake rotor having an inner hub mounting section, an outer ring, and struts connecting the inner section and outer ring, the improvement consisting of:
the struts forming figural elements.
